(19) United States
(12) Patent Application Publication
(10) Pub. No.: US 2012/0091837 A1
(43) Pub. Date: Apr. 19, 2012

(54) GENERATOR COOLING ARRANGEMENT OF A WIND TURBINE

(75) Inventors: Klaus Bodenstein, Hong Kong S.A.R. (CN); Detlef Lange, Oberhausen (DE); Dieter Rupprich, Ohne (DE)

(73) Assignee: Avantis Ltd., Hong Kong (CN)

(21) Appl. No.: 13/264,377

(22) PCT Filed: Nov. 19, 2009
(86) PCT No.: PCT/EP09/65462

§ 371 Date: Dec. 22, 2011

(30) Foreign Application Priority Data
Apr. 16, 2009 (DE) 102009017325.0

(51) Int. Cl. H02K 9/19

(52) U.S. Cl. 310/54

(57) ABSTRACT

The invention relates to a stator (1) of a generator of a wind power station or wind energy plant comprising a liquid cooling system for the region of the stator sheet stacks (5). The stator (1) comprises a plurality of axial tubes (8) and/or axial borings (7) through which a liquid cooling medium can flow, said tubes or borings extending inside or outside of the stator sheet stacks (5) over the axially extending extension, in a longitudinal manner of the periphery thereof limited or formed by the stator sheet stacks (5). The aim of the invention is to provide a solution to improve the cooling of the sheet stacks of the stator. Said aim is achieved due to the fact that the axial tubes (8) and/or the axial borings (9) are components of a cooling fluid line (15), in particular, of a closed cooling circuit, said cooling fluid line (15) running through the region which is to be cooled in a meandering manner.

The invention relates to a stator of a generator of a wind power installation or wind turbine with liquid cooling covering the region of the stator laminate stack, the stator having, along its circumference delimited or formed by the stator laminate stack, a plurality of axial pipes and/or axial bores, which extend within and/or outside the stator laminate stack over the axial longitudinal extent thereof and through which a liquid coolant can flow.

Wind turbines or wind power installations whose generator is intended to yield as high a power as possible and is intended to have as high a power density as possible require corresponding cooling of the generator. It is conventional here, as is known from EP 1 200 733 B1, for example, to provide air cooling systems in which external air is sucked in which flows around and through the generator and dissipates the heat absorbed in the process towards the outside away from the respective wind rotor or the respective wind turbine or wind power installation. In order that this does not result in increased corrosion and therefore in the life of the cooled generator being adversely affected owing to the humidity and the salt content of the external air, DE 10 2004 018 758 A1, for example, has also already proposed providing a closed coolant circuit, which is arranged exclusively within the top of the tower of a wind turbine or wind power installation and which likewise has air as the coolant.

A stator of the generic type with cooling which also comprises axial pipes and/or axial bores which are guided through the stator laminate stack and through which coolant flows is known from DE 102 53 699 A1.

With this known cooling system, the coolant flows axially from both sides completely freely onto the stator and the rotor, enters axial bores both in the rotor and in the stator and is then dissipated towards the outside from the motor housing via radial bores or radial slots. In this case, an aqueous solution is already used as coolant. There is no targeted guidance of the fluid or coolant in the region of the axial bores.

The water-cooling of generators of wind power installations or wind turbines is also known from conventional practice.

A fundamental problem when using water as coolant consists in that, owing to the high heat absorption capacity of the water which is desired along the cooling path, a steadily rising temperature of the water arises, which brings about non-uniform cooling of the generator or stator along its circumference and therefore temperature differences within the stator laminate stack or the windings. Owing to the temperature differences within the materials, different thermal expansions of the material and therefore thermal imbalances result in the generator.

The invention is based on the problem of providing a solution which enables improved cooling of the laminate stack of a stator of a wind power installation or wind turbine.

In a stator of the type mentioned at the outset, this problem is solved according to the invention by virtue of the fact that the axial pipes and/or axial bores are part of a cooling fluid line of a closed cooling circuit, said cooling fluid line passing in meandering fashion up to the region to be cooled.

The invention provides cooling or a cooling system or a cooling arrangement of a generator of a wind power installation or wind turbine in which, by means of indirect cooling by virtue of water passed through the axial pipes or axial bores as coolant, heat which is generated during operation of the generator, in particular in the form of lost heat, can be dissipated. Owing to the meandering guidance of the cooling fluid line comprising the axial pipes and/or axial bores, the water can be passed through the region to be cooled in a targeted manner beneath or within the stator laminate stack, in particular on that side of the windings which is remote from the associated rotor. In a closed cooling circuit, furthermore, there is no need for complex water preparation measures since the water is guided permanently in the circuit.

In order to form the region of the stator to be cooled, it is furthermore advantageous if the cooling fluid line which runs or is guided in meandering fashion is connected in such a way that not only does the coolant, water, flow through in each case adjacent axial pipes and/or axial bores in each case in the opposite direction, but also said pipes and/or bores are connected in such a way that it is possible to make the cooling uniform and therefore to reduce the temperature differences over the circumference of the stator laminate stack. In order to achieve this, the fluid line is divided into a plurality of cooling segments. In this case, a cooling segment comprises a plurality of axial pipes or axial bores running in the axial direction of the stator laminate stack from one side to the other side. In the exemplary embodiment, a cooling segment comprises in each case seven axial pipes and axial bores. These cooling segments are formed and arranged in each case adjacent to one another along the entire circumference of the stator laminate stack. However, they are connected in such a way that a cooling segment is connected by means of a line in each case to the next but one cooling segment by virtue of bypassing the respectively adjacent cooling segment. Only two adjacent cooling segments are connected to one another directly so as to form a return path, with this connection point preferably being located in the center of or halfway along the meandering region of the cooling fluid line. At that end of the meandering region of the cooling fluid line which is opposite this connection point, two cooling segments which are adjacent to one another but separate from one another form an outlet cooling segment and an inlet cooling segment, but these are likewise connected to one another in terms of flow and by means of lines. In this way, a cooling fluid line is provided in which, by virtue of the fact that, in the inlet region, the water is arranged with its coldest temperature adjacent to the outlet region of the water with its greatest temperature and, owing to the manner of the connections, always regions with the next highest or next lowest temperature adjoin one another, the temperature is made more uniform and is averaged out over the region of the meandering profile of the cooling fluid line. Owing to the fact that the temperature is made more uniform in this way, no significantly different regions of different thermal expansion of the stator or rotor occur which can result in a heat-related, thermal imbalance. Therefore, the invention is furthermore characterized by the fact that the stator has, at least over a section along its circumference which is delimited or formed by the stator laminate stack, a plurality of cooling segments, which each have a plurality of axial pipes and/or axial bores arranged within or outside the stator laminate stack, form the meandering region of the cooling fluid line of the, preferably closed, cooling circuit, are connected to one another by means of lines and are each connected to one another in such a way as to bypass an adjacent cooling segment. In this case, it is furthermore advantageous for the design of a closed circuit if, firstly, an inlet cooling segment and an outlet cooling segment at an end or transition region of the cooling fluid line and, secondly, two cooling segments preferably in the center of or halfway along the meandering region of the cooling fluid line are each arranged adjacent to one another and are connected to one another so as to form a return connection.

In this case, one configuration of the invention can provide that such a cooling fluid line extends over the entire circumference of the stator which is delimited or formed in the stator laminate stack. However, provision can also be made for such a cooling fluid line to extend only over a certain section of the circumference which is delimited or formed by the stator laminate stack and thus, if desired, for a plurality of such cooing fluid lines to be arranged and formed distributed over the entire circumference.

The invention is therefore firstly furthermore characterized by the fact that a meandering cooling line extends along the entire circumference which is delimited or formed by the stator laminate stack and, alternatively, by the fact that a plurality of meandering cooling lines extend along the entire circumference which is delimited or formed by the stator laminate stack.

In order to achieve uniform cooling of the stator in the region of the stator lamination, the invention furthermore provides that cooling segments are arranged along the entire circumference of 360° which is delimited or formed by the stator laminate stack.

In order to be able to form in each case corresponding deflection channels or deflection lines for forming the meandering structure of the cooling fluid line on both sides of the stator, the invention provides the possibility of the cooling segments having flow deflection elements, which are arranged in the axial direction on both sides of the stator laminate stack and/or of the stator and in particular are in the form of a chamber and/or cover.

Such flow deflection elements can have channels, with which in each case next-but-one cooling segments can be brought into fluid contact with one another. In the exemplary embodiment, flow deflection elements are formed which each cover four cooling segments and contain two line connections, with which in each case two next-but-one cooling segments of the four cooling segments are connected to one another. In order to form a generator of a wind power installation or a wind turbine which is driven without the use of a gear mechanism, it is advantageous if the generator has an external rotor and a stator, which are arranged on a common so-called “king tube”. In such a case, in accordance with one development of the invention, it is expedient if the cooling segments and/or the axial pipes and/or axial bores are arranged at the back of the stator laminate stack, which is likewise provided by the invention.

In this case, it is furthermore advantageous, in addition, if the cooling circuit passes over and/or covers the entire radial circumferential area outside, in particular beneath, the windings of the stator laminate stack. This makes it possible for the heat occurring in a generator mode of a wind power installation to be dissipated particularly well.

In this case, it is then furthermore expedient if the axial pipes and/or axial bores are arranged within or outside the stator laminate stack on that side of the windings which is remote from the rotor, with it in particular being advantageous if the axial pipes and/or axial bores are arranged within or outside the stator laminate stack beneath the windings, which is likewise provided by the invention.

It is particularly advantageous furthermore if the axial pipes and/or axial bores are arranged outside the magnetic field which can be or is induced by the windings since, as a result, there is a greater degree of freedom as regards the material which can be used for forming axial pipes and no magnetic field is induced in particular in the axial pipes.

In a particularly advantageous manner, with the type and arrangement of cooling according to the invention and the cooling system according to the invention, cooling can be provided in particular when the stator is surrounded by an external rotor, in particular one which is equipped with permanent magnets, which is likewise a feature of the invention.

In order to provide the possibility of good thermal conductivity within the stator laminate stack and to ensure good heat transfer to the axial pipes, one development of the invention provides that the axial pipes are copper pipes which are each rolled and/or pressed into an axial bore, in particular by means of widening. Copper pipes have good thermal conductivity and can emit the heat absorbed by the stator laminate stack to the water flowing within the copper pipes effectively. In order to fit the copper pipes, and in particular in order for the copper pipes to bear against the inner circumferential surface of axial bores introduced into the stator laminate stack in a particularly effective manner, the copper pipes are preferably rolled or else pressed into the bores of the stator laminate stack with widening of the diameter. As a result, the copper pipes forming the axial pipes are fixed firmly in the axial bores.

In order to ensure effective heat transfer from the material of the stator laminate stack to the copper pipes and to reduce the heat transfer resistance, a further configuration of the invention provides that that outer side of the copper pipes which bears against the inner side in each case of an axial bore is coated or provided with a thermally conductive paste.

In order to prevent cooling liquid from entering into the interspace between the outer side of the respective copper pipe and the inner circumferential surface of the respective axial bore and in this case, for example, a corrosive effect on the iron material of the stator laminate stack, the invention furthermore provides that the end-side opening cross sections of the axial bores are each sealed off from the respectively bearing copper pipe by means of an O-ring having a silicone core and a Teflon sleeve. As a result, the ingress of the respective cooling fluid, in particular water, into the interspace is prevented. Secondly, owing to the special choice of material for the O rings which consist of a silicone core and a Teflon sleeve, it is ensured that said O rings are resistant to ageing and, in addition, can withstand the relatively high temperatures occurring during operation of the generator.

The particularly preferred coolant which is particularly expedient owing to its excellent cooling effect is water, for which reason the invention is furthermore characterized by the fact that water flows, in particular is circulated or pumped around, in the cooling circuit as cooling fluid.

In order to cool the circulating cooling water or cooling fluid once it has passed through the meandering region of the cooling fluid line again, it is expedient to provide an in particular air-cooled heat exchanger or an air cooler, through which the water or the cooling liquid is passed in the way of a fluid line which connects the outlet cooling segment to the inlet cooling segment of the cooling fluid line. Therefore, the invention furthermore provides that the cooling circuit is connected to an, in particular air-cooled, heat exchanger or cooler. This heat exchanger or cooler can be arranged on the tower of a wind turbine or a wind power installation, for example, in such a way that the external air for cooling the cooling circuit can be passed by on the outside of said heat exchanger or cooler.

Finally, the invention is furthermore also characterized by the fact that the stator is part of a multi-pole synchronous generator or asynchronous generator, whose rotor, in particular external rotor, is connected to the wind rotor of the wind power installation or wind turbine, without a gear mechanism interposed. The invention can be used in an advantageous manner in particular in the case of such an installation.

The invention will be explained in more detail below by way of example with reference to a drawing, in which

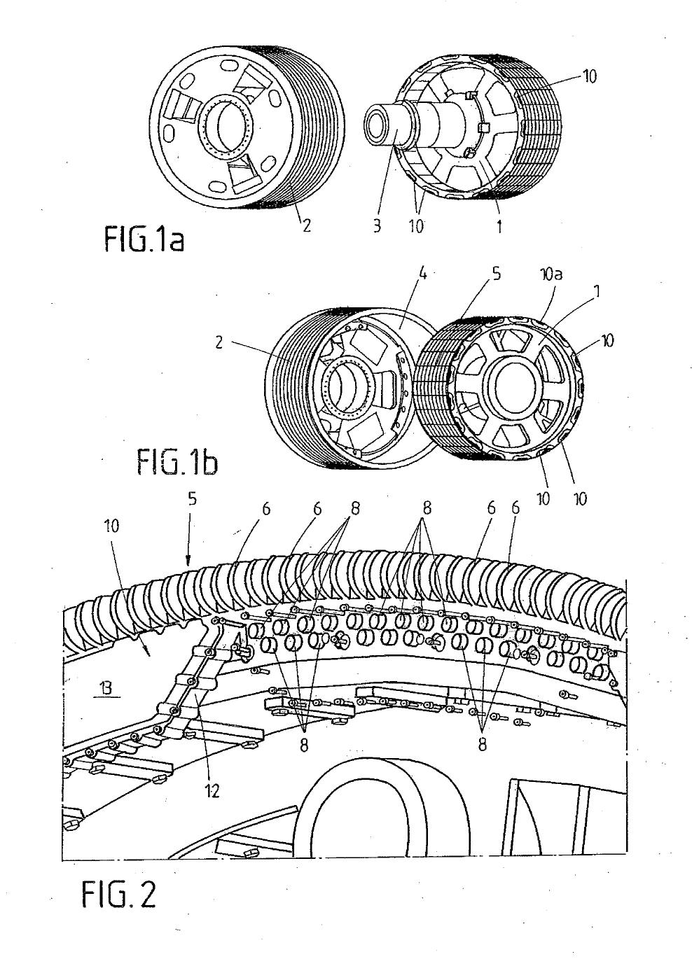

FIG. 1a shows a perspective illustration of an external view of a stator and an external rotor of a generator of a wind turbine,

FIG. 1b shows the stator and the external rotor in a perspective illustration in a view from the opposite direction in comparison with FIG. 1a,

FIG. 2 shows a perspective illustration of a detail of a side of the stator with axial pipes of a liquid cooling system which emerge from the stator laminate stack,

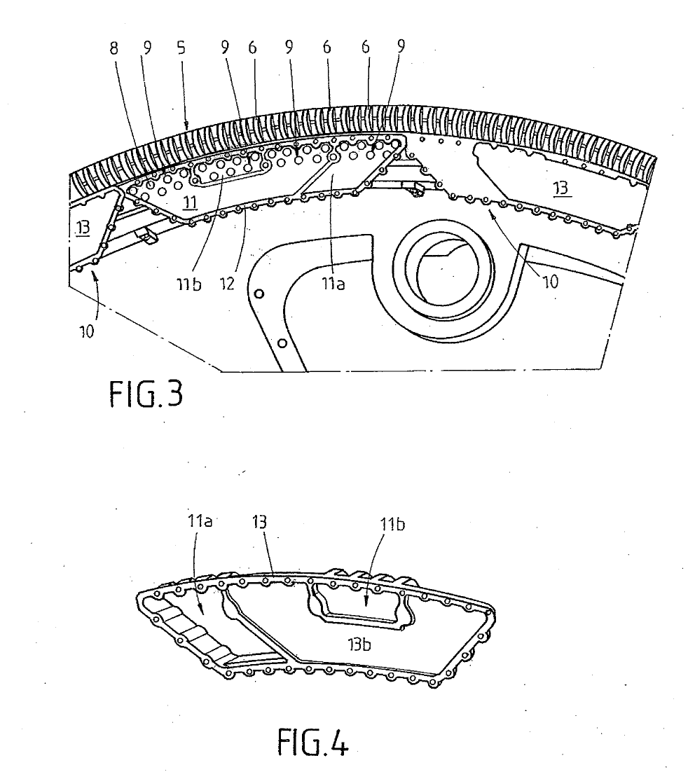

FIG. 3 shows a detail illustration of the region of the axial pipes of the liquid cooling system with the shell of a flow deflection element positioned thereon,

FIG. 4 shows a perspective illustration of the internal view of a cover of the shell of the flow deflection element which is illustrated in open form in FIG. 3,

FIG. 5 shows a view of the inner side of a shell of a flow deflection element having an inlet cooling segment, an outlet cooling segment and two cooling segments which are flow-connected to one another,

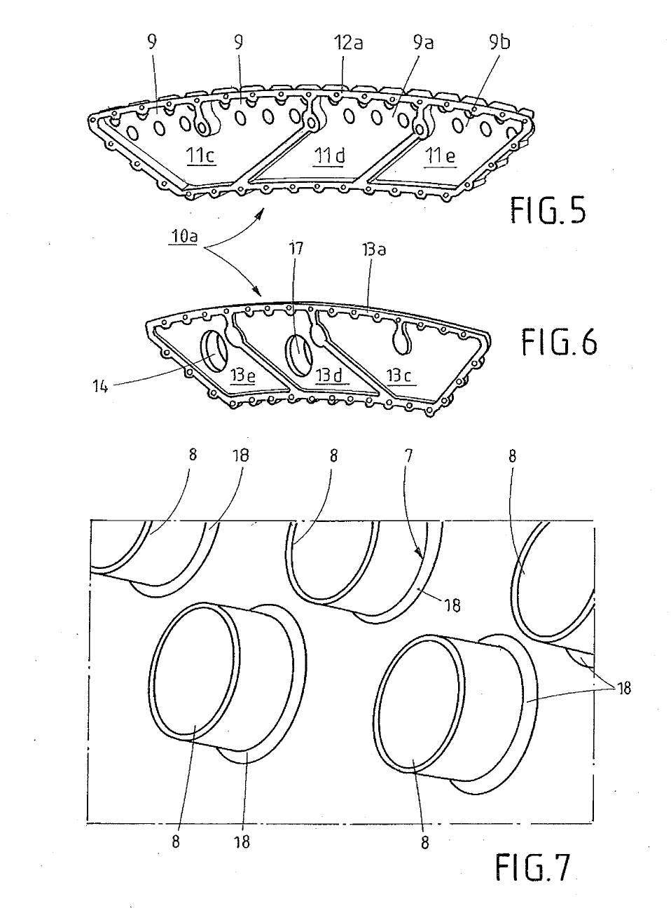

FIG. 6 shows a view of the inner side of a cover which subsequently closes the shell of the flow deflection element,

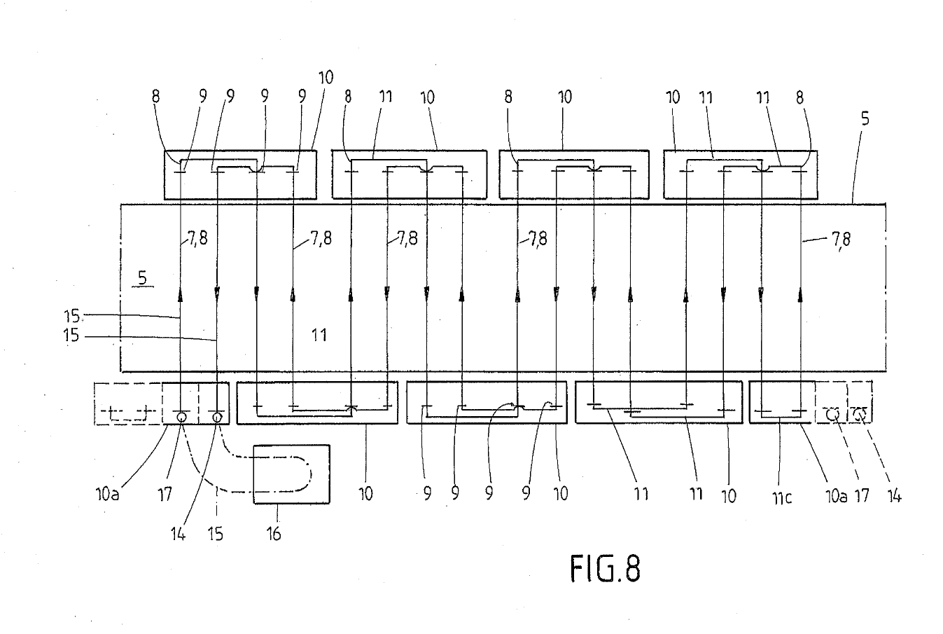

FIG. 7 shows an enlarged perspective illustration of the region where axial pipes emerge from axial bores of the cooling fluid line, and

FIG. 8 shows a schematic illustration of a developed view of a meandering cooling fluid line of a stator according to the invention.

FIGS. 1a and 1b show a stator 1, which, together with an external rotor 2 mounted on a common vertical shaft or “king tube” 3, forms the generator of a wind turbine or wind power installation. The external rotor 2 has, on the inside, an inner ring 4 constructed from permanent magnets, with the lamination segments provided with windings and forming a stator laminate stack 5 and having end windings 6 attached being arranged opposite said inner ring. The generator forms a multi-pole asynchronous generator or synchronous generator which is driven by the wind rotor in the tower of a wind power installation or a wind turbine, without a gear mechanism interposed.

Two rows of axial bores 7 which are spaced radially apart from one another and are offset circumferentially with respect to one another are provided distributed uniformly over the circumference of the stator 1 in the stator laminate stack beneath the end windings 6 and therefore beneath the winding (not shown in any more detail) of the stator 1. Copper pipes in the form of axial pipes 8 are let into the axial bores 7 and protrude slightly out of the stator laminate stack 5 on both sides, as can clearly be seen from FIG. 2 for a circumferential section. In each case seven pipes, namely three of the radially inner row and four of the radially outer row of axial pipes 8, form a cooling segment 9. A cooling segment 9 is characterized by the fact that the cooling liquid flows in each case jointly through the axial pipes 8 combined therein from one side of the stator 1 to the other side of the stator 1, as can be seen schematically also from FIG. 8, which illustrates a respective cooling segment 9 schematically as a horizontal line. In each case four cooling segments 9 are combined in a flow deflection element 10 or 10a. As can be seen in outline from FIG. 3, the individual flow deflection elements 10 each adjoin one another and, as can be seen from FIGS. 1a and 1b, form, in each case arranged in a row on both sides of the stator 1, a closed circuit along the outer circumference of the stator laminate stack 5 of the stator 1. In this case, one of the flow deflection elements forms a connection and return flow deflection element 10a, which is illustrated in FIGS. 5 and 6.

The flow deflection elements 10 each cover four cooling segments 9 and have inner connecting channels 11, which connect two in each case next-but-one cooling segments 9 in a manner which skips a respective adjacent cooling segment 9 and which enables a throughflow of coolant. In this case, each flow deflection element 10, 10a comprises a shell 12, 12a and an associated cover 13, 13a. As can be seen from FIG. 3, a shell 12 of a flow deflection element 10 delimits in each case four adjacent cooling segments 9 comprising in each case seven axial pipes 8 with respect to one another. In this case, an inner connecting channel 11 which connects two cooling segments 9 is formed within the shell 12, while the connection of the two remaining next-but-one cooling segments 9 is produced with the aid of an inner connecting channel 11 formed in the cover 13, with the entry and exit regions 11a, 11b of said inner channel being illustrated in the internal view of the cover 13 shown in FIG. 4, said entry and exit regions corresponding to the correspondingly delimited regions 11a and 11b in FIG. 3. The cover 13 is formed so as to be congruent with the surface of the shell 12 and has a flat region 13b, which closes the inner channel 11, and the inner connecting channel 11, which comprises the regions 11a and 11b.

In this way, flow deflection elements 10 are arranged on both sides of the stator 1, but said flow deflection elements are arranged so as to be offset with respect to one another by two cooling segments 9, as can be seen from FIG. 8. Then, a flow deflection element 10a, which is formed from a shell 12a, whose internal view is shown in FIG. 5, and a cover 13a, whose internal view is shown in FIG. 6, is arranged on one side of the stator 1. In the flow deflection element 10a, the shell 12a forms an inner return channel 11c, which connects two adjacently arranged cooling segments 9 to one another. Furthermore, the two further cooling segments 9 of the flow deflection element 10a end in an inlet section 11d and an outlet section 11e, with the result that these cooling segments 9 of the flow deflection element 10a form an inlet cooling segment 9a and an outlet cooling segment 9b. The cover 13a is formed in congruent fashion with respect thereto in such a way that its section 13c covers the inner return channel 11c, and the cover section 13d covers the inlet section 11d and the cover section 13e covers the outlet section 11e. The cooling fluid line, which is denoted overall by 15 and is guided through the stator laminate stack 5 in meandering fashion with the aid of the flow deflection elements 10, 10a, as can be seen from FIG. 8, is connected by means of lines to a heat exchanger 16 via the outlet opening 14, wherein this region of the line is passed back to the inlet opening 17 in the cover section 13d of the cover 13a once it has passed through the heat exchanger 16. This results in a closed water circuit which comprises the meandering cooling fluid line 15 with the feed and discharge line to and from the air-cooled heat exchanger 16. Having been cooled in the heat exchanger 16, the liquid water used as cooling fluid passes through the inlet opening 17 into the meandering region of the cooling fluid line 15 and flows through said cooling fluid line in the direction of the arrows illustrated, is fed back at the flow deflection element 10a and emerges from the meandering region of the cooling fluid line 15 at the outlet opening 14 and is passed, as a continuation of the cooling fluid line 15, through the heat exchanger 16, where the coolant, water, then emits the absorbed heat to the surrounding air by means of the heat exchanger 16 and then, having been cooled again, is fed to the meandering region of the cooling fluid line 15.

The circulation in the circuit is performed with the aid of a pump (not illustrated).

The cooling segments 9, 9a, 9b and the axial pipes 8 and the axial bores 7 are arranged at the back of the stator laminate stack 5, with the result that the cooling circuit formed overall by means of the cooling fluid line 15 passes over and covers the entire radial circumferential area outside, and also beneath in the present exemplary embodiment, the windings of the stator laminate stack 5. In this case, the axial pipes 8 and the axial bores 7 are arranged within the stator laminate stack 5 on that side of the windings which is remote from the external rotor 2. In this case, the axial pipes 8 and the axial bores 7 are spaced so far apart from the winding that the axial pipes 8 and the axial bores 7 are arranged outside the magnetic field which can be or is induced by the windings.

Even if the axial pipes 8 and the axial bores 7 are formed in the stator laminate stack 5 in the present example, it is also possible for said axial pipes and said axial bores to be arranged and formed in a material ring consisting of metal which is arranged beneath the actual stator laminate stack in the form of a circular ring.

In order to achieve effective thermal conduction and effective heat transfer onto the coolant, water, flowing in the axial pipes 8 from the iron-containing stator laminate stack 5 or the annular metal material, the axial pipes 8 consist of copper pipes, which are applied fixedly to the inner circumferential surface of the axial bores 7 and are therefore fixed in the axial bores 7 by means of being rolled in or pressed in and/or widened. In order to further improve the heat transfer and to reduce the heat transfer resistance, the outer circumferential surface of the copper pipes is coated and provided with a thermally conductive paste prior to the widening or rolling-in of the copper pipes, with the result that particularly intensive heat conduction from the iron material surrounding the copper pipe into the copper pipe and from said copper pipe into the liquid and coolant, water, flowing therein is brought about. The end-side opening cross section of each axial bore 7 is in this case sealed off from the respectively bearing axial pipe 8 in the form of a copper pipe by means of an O-ring 18 having a silicone core and a Teflon sleeve.

The meandering guidance of the cooling fluid line 15 illustrated in FIG. 8 means that the cooling fluid, water, flows through the axial pipes 7 of adjacent cooling segments 9, said axial pipes being positioned in each case in the region of the stator laminate stack 5, in each case in the opposite direction, wherein, owing to the fact that the respectively adjacent cooling segment is skipped and owing to the formation of the flow deflection element 10a having the inner return channel 11c, it is the case that, starting from the outlet opening 14 and the inlet opening 17, in each case cooling segments 9 are arranged next to one another, in which the coolant is at its highest and lowest temperature, followed by adjacent cooling segments which have a coolant flow with its next-lowest and next-highest temperature and so on and so forth, such that a standardized temperature is set within the stator laminate stack 5 over the entire length of the meandering region of the cooling fluid line 15 and thus the formation of thermally induced, imbalance in the stator 1 is avoided, or else at least markedly reduced.

1. A stator of a generator of a wind power installation or wind turbine with liquid cooling covering the region of the stator laminate stack, the stator comprising, along its circumference delimited or formed by the stator laminate stack a plurality of axial pipes and/or axial bores, which extend within and/or outside the stator laminate stack over the axial longitudinal extent thereof and through which a liquid coolant can flow, wherein the axial pipes and/or axial bores are part of a cooling fluid line of a cooling circuit, said cooling fluid line passing in meandering fashion up to the region to be cooled.

2. The stator as claimed in claim 1, wherein the stator has, at least over a section along its circumference which is delimited or formed by the stator laminate stack a plurality of cooling segments which each have a plurality of axial pipes and/or axial bores arranged within or outside the stator laminate stack form the meandering region of the cooling fluid line of the cooling circuit, are connected to one another by means of lines and are each connected to one another in such a way as to bypass an adjacent cooling segment.

3. The stator as claimed in claim 1, wherein, firstly, an inlet cooling segment and an outlet cooling segment at an end or transition region of the cooling fluid line and, secondly, two cooling segments are each arranged adjacent to one another and are connected to one another so as to form a return connection.

4. The stator as claimed in claim 2, wherein a meandering cooling line extends along the entire circumference which is delimited or formed by the stator laminate stack.

5. The stator as claimed in claim 2, wherein a plurality of meandering cooling lines extend along the entire circumference which is delimited or formed by the stator laminate stack.

6. The stator as claimed in claim 1, wherein cooling segments are arranged on both sides along the entire circumference of 360° which is delimited or formed by the stator laminate stack.

7. The stator as claimed in claim 1, wherein the cooling segments have flow deflection elements which are arranged in the axial direction on both sides of the stator laminate stack and/or of the stator.

8. The stator as claimed in claim 1, wherein the cooling segments and/or the axial pipes and/or axial bores are arranged at the back of the stator laminate stack.

9. The stator as claimed in claim 1, wherein the cooling circuit passes over and/or covers the entire radial circumferential area outside the windings of the stator laminate stack.

10. The stator as claimed in claim 1, wherein the axial pipes and/or axial bores are arranged within or outside the stator laminate stack on that side of the windings which is remote from the rotor.

11. The stator as claimed in claim 1, wherein the axial pipes (8) and/or axial bores are arranged within or outside the stator laminate stack beneath the windings.

12. The stator as claimed in claim 1, wherein the axial pipes and/or axial bores are arranged outside the magnetic field which can be or is induced by the windings.

13. The stator as claimed in claim 1, wherein it is surrounded by an external rotor.

14. The stator as claimed in claim 1, wherein the axial pipes are copper pipes which are each rolled and/or pressed into an axial bore.

15. The stator as claimed in claim 1, that wherein the outer side of the copper pipes which bears against the inner side in each case of an axial bore is provided with a thermally conductive paste.

16. The stator as claimed in claim 1, wherein the end-side opening cross sections of the axial bores are each sealed off from the respectively bearing copper pipe by means of an O-ring having a silicone core and a Teflon sleeve.

17. The stator as claimed in claim 1, wherein water flows in the cooling circuit as cooling fluid.

18. The stator as claimed in claim 1, wherein the cooling circuit is connected to a heat exchanger or cooler.

19. The stator as claimed in claim 1, wherein it is part of a multi-pole synchronous generator or asynchronous generator, whose rotor is connected to the wind rotor of the wind power installation or wind turbine, without a gear mechanism interposed.

20. A stator as claimed in claim 1, wherein the cooling circuit is a closed cooling circuit.

21. The stator as claimed in claim 20, wherein the stator has, at least over a section along its circumference which is delimited or formed by the stator laminate stack a plurality of cooling segments which each have a plurality of axial pipes and/or axial bores arranged within or outside the stator laminate stack form the meandering region of the cooling fluid line of the closed cooling circuit, are connected to one another by means of lines and are each connected to one another in such a way as to bypass an adjacent cooling segment.

22. The stator as claimed in claim 3, wherein two cooling segments in the center of or halfway along the meandering region of the cooling fluid line are each arranged adjacent to one anther and are connected to one another so as to form a return connection.

23. The stator as claimed in claim 7, wherein the cooling segments have flow deflection elements which are arranged in the form of a chamber and/or cover.

24. The stators claimed in claim 9, wherein the cooling circuit passes over and/or covers the entire radial circumferential area beneath the windings of the stator laminate stack.

25. The stator as claimed in claim 13, wherein the external rotor is equipped with permanent magnets.

26. The stator as claimed in claim 14, wherein the axial pipes are each rolled and/or pressed into an axial bore by widening.

27. The stator as claimed in claim 17, wherein the water is circulated or pumped around in the cooling circuit.

28. The stator as claimed in claim 18, wherein the heat exchanger or cooler is air-cooled.

29. The stator as claimed in claim 19, wherein it is part of a multi-pole synchronous generator or asynchronous generator, whose external rotor, is connected to the wind rotor of the wind power installation or wind turbine, without a gear mechanism interposed.
